(19) United States
(12) Patent Application Publication
(10) Pub. No.: US 2025/0197203 A1
(43) Pub. Date: Jun. 19, 2025

(54) SYSTEMS AND METHODS FOR CONVERTING ORTHO HYDROGEN TO PARA HYDROGEN

(71) Applicant: CHEVRON U.S.A. INC., San Ramon, CA (US)

(72) Inventors: Curtis Lee KRAUSE, San Ramon, TX (US); KEVIN JAKUBENAS, San Ramon, CA (US)

(21) Appl. No.: 18/985,441

(22) Filed: Dec. 18, 2024

Related U.S. Application Data
(60) Provisional application No. 63/611,521, filed on Dec. 18, 2023.

(51) Int. Cl. C01B 3/00; B01J 19/00; B01J 19/08; B01J 19/24; F25B 21/00

(52) U.S. Cl. CPC C01B 3/0089; B01J 19/0013; B01J 19/087; B01J 19/2485; F25B 21/00; B01J 2219/0006; B01J 2219/00076; B01J 2219/00139; B01J 2219/00204; B01J 2219/0856; B01J 2219/0869; B01J 2219/0871; B01J 2219/2416; B01J 2219/2428; B01J 2219/2434; F25B 2321/0021

(57) ABSTRACT

The present embodiments include systems and methods for converting ortho hydrogen to para hydrogen using, for example, a heat exchange wall that may be coated with a catalyst material.

### CROSS REFERENCE TO RELATED APPLICATION(S)

This application related to U.S. Provisional Patent Application Ser. No. 63/611,521, filed on Dec. 18, 2023, the entire disclosure of which is incorporated herein by reference.

### FIELD OF THE DISCLOSURE

The present disclosure relates to a device for converting ortho hydrogen to para hydrogen

### BACKGROUND

In the liquefaction of hydrogen, the conversion of the ortho nuclear spin state to the para nuclear spin state is often useful as the heat of this conversion is greater than the heat of vaporization of hydrogen. This means that even in a perfectly adiabatic container, hydrogen that is liquefied without ortho-to-para conversion will boil off more than half of the liquid as the hydrogen reaches nuclear spin equilibrium. Reaching equilibrium without a catalyst can often require hours to days, creating a bottleneck in the liquefaction process. With a catalyst, the conversion can happen in, for example, seconds. The catalyst often provides two functions, enhancing the nuclear spin change and absorbing the heat released. The most common catalyst used is iron oxide in small particles packed into a bed.

Unfortunately, packed beds often suffer from at least two problems. First, the pressure drop across the bed is problematic because hydrogen is energy intensive to compress. Therefore, the pressure drop contributes to inefficiencies in the liquefaction plant. Second, the packed bed has limited ability to transfer the heat from the ortho-to-para conversion resulting in further inefficiencies. These two sources of inefficiency are significant and therefore there is a need to improve ortho-para transition systems, catalysts, and methods.

### SUMMARY OF THE DISCLOSURE

Aspects of the disclosed embodiments include a monolith with an ortho-to-para catalyst in the wall of a heat exchanger.

In some aspects, the techniques described herein relate to a device for converting ortho hydrogen to para hydrogen including: a heat exchanger further including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; a cooling system configured to remove heat from an ortho hydrogen to para hydrogen conversion; a monolith within the flow system, wherein the monolith includes one or more channels for flowing through hydrogen, wherein ortho hydrogen and para hydrogen can flow through the channels one or more times; a permanent magnet; an electromagnet; and a magnetocaloric material between the permanent magnet and the electromagnet, wherein the permanent magnet and the electromagnet are configured to create a magnetic field that accelerates conversion of the ortho hydrogen to the para hydrogen and removes heat through a magnetocaloric effect.

In some aspects, the techniques described herein relate to a device for converting ortho hydrogen to para hydrogen including: a heat exchanger further including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; a cooling system configured to remove heat from a ortho hydrogen to para hydrogen conversion; and a monolith within the flow system, wherein the monolith includes one or more channels for flowing through hydrogen, wherein ortho hydrogen and para hydrogen can flow through the channels one or more times.

In some aspects, the techniques described herein relate to a device for converting ortho hydrogen to para hydrogen including: a heat exchanger further including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; and a cooling system configured to remove heat from a ortho hydrogen to para hydrogen conversion.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram illustrating a reactor according to an exemplary embodiment.

FIG. 2A is a diagram illustrating a reactor according to an exemplary embodiment.

FIG. 2B is a diagram illustrating a reactor according to an exemplary embodiment.

FIG. 3A is a diagram illustrating a reactor according to an exemplary embodiment.

FIG. 3B is a diagram illustrating a reactor according to an exemplary embodiment.

FIG. 4 shows an end view of a reactor according to an exemplary embodiment.

FIG. 5 shows a side view of a reactor according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

To perform hydrogen liquefaction, hydrogen is typically cooled. Two spin isomers of hydrogens are para hydrogen (para) and ortho hydrogen (ortho). Ortho hydrogen molecules are those in which the spins of both the nuclei are in the same direction. Molecules of hydrogen in which the spins of both the nuclei are in the opposite direction are called para hydrogen. The amount of ortho and para hydrogen vary with temperature. At near OK, hydrogen contains mainly para hydrogen which is more stable. At the temperature of liquefaction of air, the ratio of ortho and para hydrogen is usually about 1:1. At room temperature, the ratio of ortho to para hydrogen is often about 3:1. Parahydrogen, in which the two nuclear spins are antiparallel, is more stable than orthohydrogen, in which the two are parallel. At room temperature, gaseous hydrogen is mostly in the ortho isomeric form, but an ortho-enriched mixture is only metastable when liquefied at low temperature. It slowly undergoes an exothermic reaction to become the para isomer, with enough energy released as heat to cause some of the liquid to boil. To prevent loss of the liquid during long-term storage, it is therefore intentionally converted to the para isomer as part of the production process, typically using a catalyst such as iron (III) oxide, activated carbon, platinized asbestos, rare earth metals, uranium compounds, chromium (III) oxide, and/or some nickel compounds.

As described above, conventional systems often rely on packed bed reactors to liquefy hydrogen. Packed beds can be inefficient for heat transfer and have a significant pressure drop from inlet to outlet. Furthermore, temperature gradients may occur; the catalyst within the packed beds are difficult to replace; and side reactions can be possible.

As described herein, the inventive systems and methods incorporate the ortho-to-para catalyst in the wall of a heat exchanger, avoiding the need for a separate catalyst bed and reducing the pressure drop in the system.

A second aspect that may be included (but is separate from incorporating the catalyst into the heat exchanger wall) is to also incorporate magnetocaloric materials into the wall of the heat exchanger. Magnetocaloric materials (such as gadolinium or iron phosphate) absorb and release heat when a magnetic field is switched on and off. The magnetocaloric material serves at least two functions, first is heat removal. Second, magnetic fields enhance the ortho-para conversion related to hydrogen liquefaction. It has been discovered that there are potential alloys that could exhibit both ortho-para catalytic capability as well as magnetocaloric capability (such as gadolinium or ruthenium alloys). Incorporating a catalyst into a heat exchange wall according to the present embodiments offers a different mechanism and/or intent of the catalyst. In conventional systems, the catalyst reduced activation energy for a chemical reaction. In the present embodiments, the catalyst additionally or alternatively creates a magnetic moment for a nuclear spin change and absorbs energy from the spin change. In conventional systems, heat exchangers are employed to add heat to a reaction. However, in the present embodiments, the heat exchanger is employed to remove heat from the reaction. Moreover, adding a magnetocaloric material to the heat exchanger and using magnetic fields advantageously accelerates the ortho-para conversion in the novel systems, methods, and apparatuses described herein.

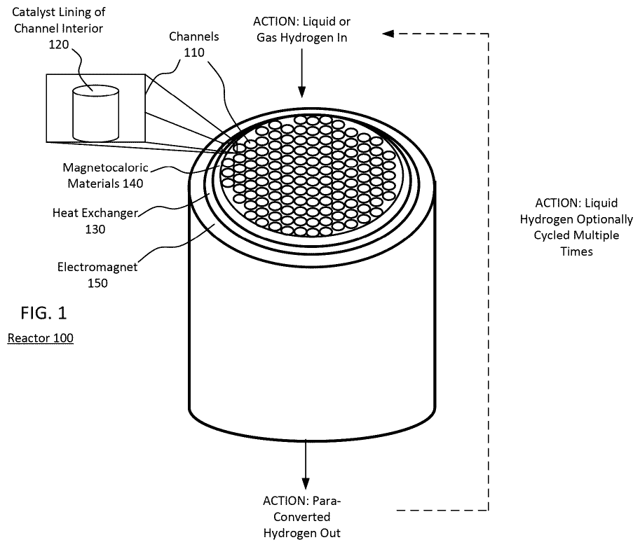

FIG. 1 illustrates a monolithic reactor suitable for hydrogen liquefaction with an ortho-para catalyst lined heat exchanger. The reactor 100 can be a monolithic reactor with a number or plurality of channels 110. In some embodiments, the monolith can comprise extruded ceramic honeycomb-like structures. In other embodiments, the monolith can include, a metal structure could be used which is typically corrugated metal spiral wound. It is understood that although the channels 110 are illustrated as round or circular, in other embodiments the channels may be square, hexagonal, or some other shape. The channel density may vary, and the separating walls between the channels can vary in dimensions as well. The number, density, and wall separation can vary according to needs for desirable resistance flow, the minimization of energy needed to force liquid through the channels, and/or surface area of the channels. Surrounding the channels 110 is often a catalyst lining 120, or some catalyst wall.

The catalyst lining 120 can include some catalyst suitable for initiating, performing, or quickening the ortho-to-para conversion. As a nonlimiting example, the catalyst lining 120 can include without limitation as iron (III) oxide, activated carbon, platinized asbestos, rare earth metals, uranium compounds, chromium (III) oxide, and/or some nickel compounds. In other embodiments, the catalyst lining 120 can include an oxide of a metal including without limitation V, Cr, Mn, Fe, Co, Ni, Nd, Pm, Sm, Gd, Eu, Tb, Dy, Ho, and Er or some combination thereof.

The thickness of the catalyst lining 120 can vary to any degree suitable to performing the ortho-to-para conversion. In some embodiments, the catalyst lining 120 can be removably attached to the heat exchanger 130 by way of some secure attachment. In some embodiments, some, or all of the channels 110 can be lined with catalyst lining. The heat exchanger 130 is responsible for absorbing the heat emitted from the reaction between the hydrogen and the catalyst lining 120. The heat exchanger 130 can include any suitable configuration of materials for absorbing the heat, including without limitation a tube heat exchanger, a tube in tube heat exchanger, a fin heat exchanger, spiral wound, or any combination thereof. The heat exchanger 130 can absorb the heat from the reaction and, if desired, reuse the heat for a different and separate reaction, or optionally the heat exchanger can recycle the heat into itself through one or more means of heat transfer including without limitation one or more pipes. The heat exchanger 130 can include without limitation one or more shells, tubes, tube nest or tube bundles, baffles, tube sheets, and tube stacks. In other embodiments, the reactor can include one or more additional elements including one or more layers of insulation, an exterior wall, and/or an annulus. Within the heat exchanger 130 layer can be a layer of magnetocaloric materials 140. Outside of the heat exchanger 130 layer can be an electromagnet 150. The magnetocaloric materials 140 produces heat when the magnetic field created by the electromagnet 150. Thus, the magnetocaloric material 140 further regulates that heat produce and recycled throughout the reactor 100 as a result of the hydrogen conversion. The magnetocaloric materials 140 can include any magnetocaloric material or combination of materials including without limitation gadolinium or iron phosphate, or even gadolinium or ruthenium alloys or any magnetocaloric mixture thereof.

In use, the reactor 100 works at least in the following way: hydrogen enters the reactor 100 in liquid or gas form. The hydrogen can enter the one or more channels 110 and can come into contact with the catalyst lining 120. The reaction from contact emits heat, and the heat is absorbed by the heat exchanger 130. The catalyzed hydrogen flows out of the reactor 100, at which point that catalyzed hydrogen may be fed elsewhere for storage or optionally be fed through the reactor 100 multiple times for further processing.

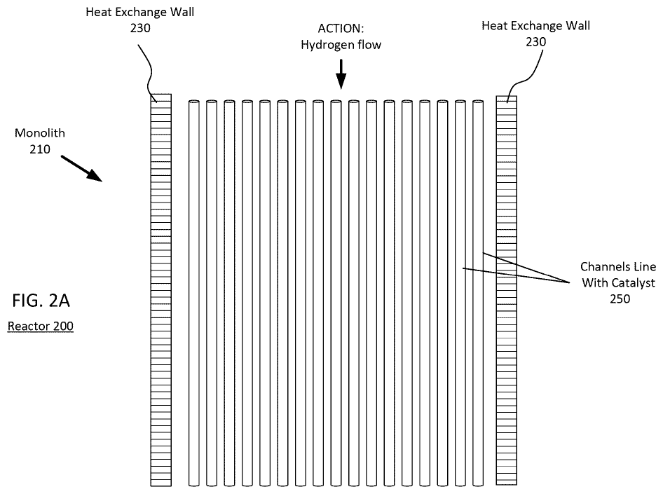

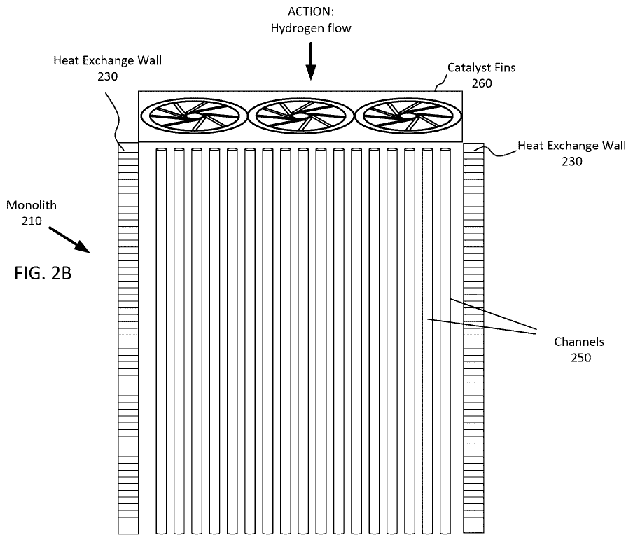

FIG. 2A illustrates a cross section of a reactor 200. The reactor 200 can include a heat exchange wall 230 and an ortho-to-para catalyst 220 lining the wall. The reactor 200 can include a monolithic structure 210 similar to that described in FIG. 1. In other embodiments hydrogen can flow freely through a single channel lined with the catalyst 220. It should be understood that while a single channel is shown there may be two or more channels employed if desired.

As a nonlimiting example, the catalyst lining 210 can include without limitation as iron (III) oxide, activated carbon, platinized asbestos, rare earth metals, uranium compounds, chromium (III) oxide, or some nickel compounds. In other embodiments, the catalyst lining 120 can include an oxide of a metal including without limitation V, Cr, Mn, Fe, Co, Ni, Nd, Pm, Sm, Gd, Eu, Tb, Dy, Ho, and Er or some combination thereof. The hydrogen can flow through the monolith 230, come into contact with the catalyst 220, and emit heat. The emitted heat can be absorbed, recycled, and/or otherwise used by the heat exchange wall 230, which included at least the same or similar elements and variations as described elsewhere herein.

FIG. 2B illustrates a different version of the monolith 210 with one or more fins coated with catalyst material 260. The fins 260 facilitate hydrogen flow through the channels 250 and also accelerate the ortho-to-para conversion. In some embodiments, both the fins 260 and the channels 250 can have a catalyst lining. In other embodiments, one or the other can have a catalyst lining.

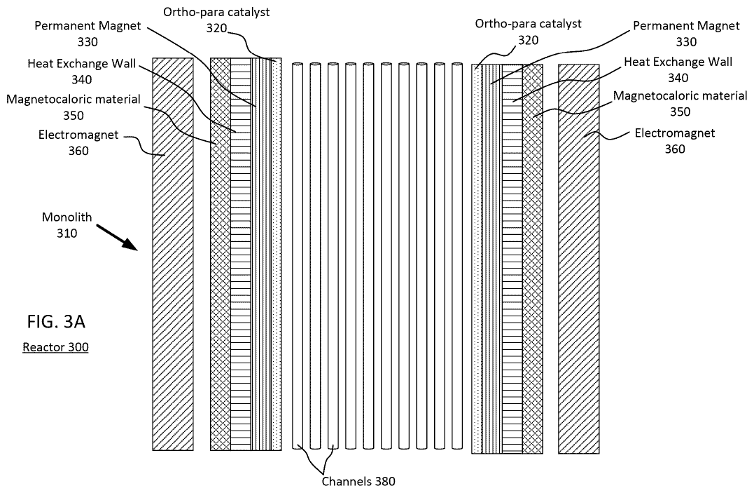

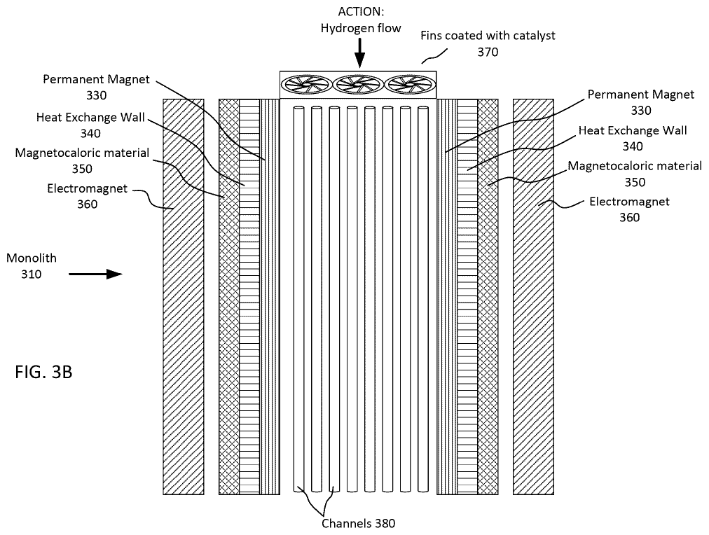

FIG. 3 illustrates a cross section of a reactor 300. The reactor 300 can include at least a monolith 310, an ortho-to-para catalyst 320, a permanent magnet 330, a heat exchange wall 340, a magnetocaloric material 350, and an electromagnet 360. The reactor 300 can include a monolithic structure 310 similar to that described in FIG. 1. It should be understood that while a single channel is shown there may be two or more channels employed if desired.

In other embodiments the hydrogen can flow freely through a single channel lined with the catalyst 320. As a nonlimiting example, the catalyst lining 320 can include without limitation as iron (III) oxide, activated carbon, platinized asbestos, rare earth metals, uranium compounds, chromium (III) oxide, or some nickel compounds. In other embodiments, the catalyst lining 320 can include an oxide of a metal including without limitation V, Cr, Mn, Fe, Co, Ni, Nd, Pm, Sm, Gd, Eu, Tb, Dy, Ho, and Er or some combination thereof. The magnetocaloric material 350 produces heat when the magnetic field created by the electromagnet 360 and the permanent magnet 330 is applied. Thus, the magnetocaloric material 350 further regulates that heat produce and recycled throughout the reactor 300 as a result of the hydrogen conversion. The magnetocaloric materials 350 can include any magnetocaloric material or combination of materials including without limitation gadolinium or iron phosphate, or even gadolinium or ruthenium alloys or any magnetocaloric mixture thereof.

The magnetocaloric material 350 may serve two functions. The first is heat removal. Second, magnetic fields enhance the ortho-para conversion related to hydrogen liquefaction. Advantageously, the magnetocaloric material 350 can be turned on and off according to the needs of the reaction. Hydrogen can enter the reactor 300, react with the catalyst 320, emit heat, and be stored or recycled for immediate or later use. The reaction can be facilitated by the magnetocaloric material 350 upon interacting with a magnetic field created by the electromagnet 360 and the permanent magnet 330. The heat emitted by the reaction can be absorbed at least in part by the heat exchange wall 340. The hydrogen liquid or gas can generally flow through one or more of the channels 380. The channels 380 can further be lined with catalyst material.

FIG. 3B illustrates a different version of the monolith 310 with one or more fins coated with catalyst material 370. The fins 370 facilitate hydrogen flow through the channels 250 and also accelerate the ortho-to-para conversion. In some embodiments, both the fins 260 and the channels 250 can have a catalyst lining. In other embodiments, one or the other can have a catalyst lining.

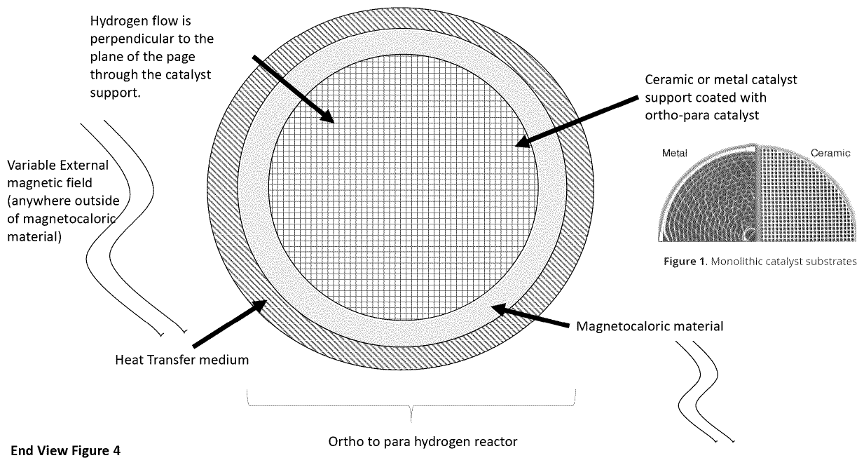

FIG. 4 shows an end view of a representative ortho to para hydrogen reactor. Hydrogen flow is perpendicular to the plane of the page through the catalyst support which may be, for example, a ceramic or metal catalyst support coated with ortho-para catalyst. However, it should be appreciated other configurations may be employed. A magnetocaloric material surrounds the catalyst support and, if desired, a heat transfer medium surrounds the magnetocaloric material. Of course, in some embodiments the magnetocaloric material and heat transfer medium could be in different configurations or even the same material.

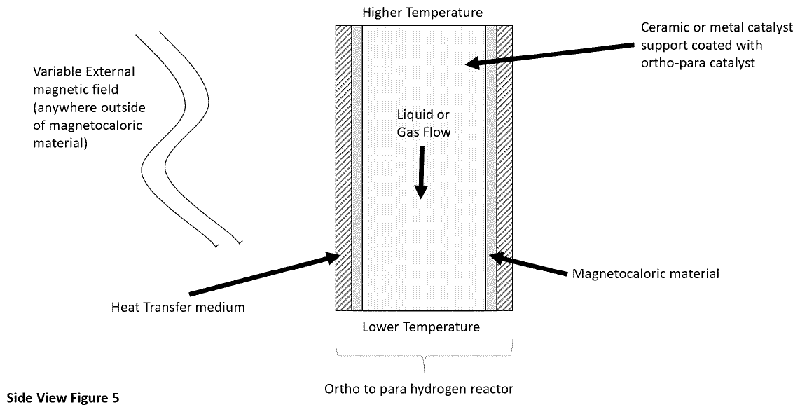

A side view of the reactor of FIG. 4 is shown in FIG. 5.

### Advantageous Aspects

(1) In some embodiments, the invention provides for a combination of a surface catalyst with a monolith support (current state of the art is a packed bed of powder which increases pressure drop and requires more compressor energy and expensive cryogenic compressors).
(2) In some embodiments, the invention provides for a temperature gradient along reactor
this maximizes efficiency by allowing heat to be removed from the ortho-para transition closer to equilibrium (current state of the art is multiple stages each at a different temperature which leads to non-equilibrium heat removal/entropy generation that is inefficient)
(3) In some embodiments, the invention provides for incorporating a magnetic field to (a) increase activity of the catalyst and/or trigger the magnetocaloric effect in specific magnetocaloric materials to pump heat from the reactor to the heat transfer medium.
(4) In some embodiments, the invention provides for one or more up to all of (1) to (3) described immediately above.

### Embodiments

In some aspects, the techniques described herein relate to a device for converting ortho hydrogen to para hydrogen including: a heat exchanger including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; a cooling system configured to at least partially remove heat from an ortho hydrogen to para hydrogen conversion; a monolith within the flow system, wherein the monolith includes one or more channels for flowing hydrogen therethrough and wherein the monolith is configured such that ortho hydrogen and para hydrogen can flow through the one or more channels one or more times; a permanent magnet; an electromagnet; and a magnetocaloric material between the permanent magnet and the electromagnet, wherein the permanent magnet and the electromagnet are operably connected to the monolith and configured to create a magnetic field that (1) accelerates conversion of the ortho hydrogen to the para hydrogen, (2) removes heat through a magnetocaloric effect, or (3) both (1) and (2).

In some aspects, the techniques described herein relate to a device, wherein the magnetic field is configured to controllably increase or decrease a temperature of the magnetocaloric material.

In some aspects, the techniques described herein relate to a device, wherein the heat exchanger is selected from one of a tube heat exchanger, a tube in tube heat exchanger, a fin heat exchanger, spiral wound, or any combination thereof.

In some aspects, the techniques described herein relate to a device in which the catalytic material includes an oxide of a metal selected from one of V, Cr, Mn, Fe, Co, Ni, Nd, Pm, Sm, Gd, Eu, Tb, Dy, Ho, and Er or any combination thereof.

In some aspects, the techniques described herein relate to a device in which the device is configured such that the magnetic field is activated, deactivated, or both according to the heat removal needs of the heat exchanger.

In some aspects, the techniques described herein relate to a device in which the device is configured such that the magnetic field varies based on a temperature profile of the heat exchanger such that the temperature at which heat is extracted is substantially maximized.

In some aspects, the techniques described herein relate to a device in which the device is configured such that the magnetic field varies based on a geometry of the heat exchanger such that the temperature at which heat is extracted is substantially maximized.

In some aspects, the techniques described herein relate to a device in which the device is configured such that the magnetic field varies separately for the catalytic material and the magnetocaloric heat exchanger.

In some aspects, the techniques described herein relate to a device wherein the cooling system is configured to remove at least a portion of the heat of the ortho to para hydrogen conversion using a magnetocaloric effect.

In some aspects, the techniques described herein relate to a device in which the magnetocaloric material includes an oxide of a metal selected from one of V, Cr, Mn, Fe, Co, Ni, Nd, Pm, Sm, Gd, Eu, Tb, Dy, Ho, and Er or any combination thereof.

In some aspects, the techniques described herein relate to a device in which the magnetocaloric material includes one or more metals selected from one of Al, Si, Ca, V, Cr, Mn, Fe, Co, Ni, La, Nd, Pm, Sm, Gd, Eu, Tb, Dy, Ho, Er, or any combination thereof.

In some aspects, the techniques described herein relate to a device for converting ortho hydrogen to para hydrogen including: a heat exchanger including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; a cooling system configured to remove heat from an ortho hydrogen to para hydrogen conversion; and a monolith, wherein the monolith includes one or more channels for flowing hydrogen therethrough, wherein the monolith is configured such that ortho hydrogen and para hydrogen can flow through the one or more channels one or more times.

In some aspects, the techniques described herein relate to a device, wherein the one or more channels are coated in the catalytic material.

In some aspects, the techniques described herein relate to a device, wherein the heat exchanger is selected from a tube heat exchanger, a tube in tube heat exchanger, a fin heat exchanger, spiral wound, or any combination thereof.

In some aspects, the techniques described herein relate to a device, wherein the channels include a cross-section which is circular, square, or hexagonal.

In some aspects, the techniques described herein relate to a device, wherein the device further includes a temperature gauge configured to measure the heat exchanger temperature.

In some aspects, the techniques described herein relate to a device, wherein the device further includes a temperature profile processor configured to generate a temperature profile of the heat exchanger over a predetermined period of time during use.

In some aspects, the techniques described herein relate to a device, wherein the catalytic material includes iron oxide, chromium oxide, ruthenium oxide or any combination thereof.

In some aspects, the techniques described herein relate to a device, wherein the device is configured to produce liquid hydrogen suitable for fuel consumption.

In some aspects, the techniques described herein relate to a device for converting ortho hydrogen to para hydrogen including: a heat exchanger including an integrated heat removal system; a catalytic material coated on the heat exchanger, wherein the catalytic material is configured to convert ortho hydrogen to para hydrogen; a flow system configured to flow hydrogen through the heat exchanger upon the hydrogen contacting the catalytic material; and a cooling system configured to remove heat from an ortho hydrogen to para hydrogen conversion.

In some aspects, the techniques described herein relate to a device, wherein the device further includes a monolith further including one or more channels configured for the flow of hydrogen, wherein the one or more channels are included of extruded ceramic honeycomb-like structures, wherein the interior of each channel is coated in the catalytic material.

In some aspects, the techniques described herein relate to a device, wherein the device further includes a monolith further including one or more channels configured for the flow of hydrogen, wherein the monolith further shaped in a corrugated metal spiral wound.

In some aspects, the techniques described herein relate to a device, wherein the device further includes: a monolith further including one or more channels configured for the flow of hydrogen; one or more heat transfer fins configured to facilitate the flow of hydrogen through the one or more channels, wherein each heat transfer fin is coated in the catalytic material.

In some aspects, the techniques described herein relate to a process for converting ortho hydrogen to para hydrogen including: flowing a gas including ortho hydrogen through one or more channels of a monolith in the presence of a catalyst under conditions to convert ortho hydrogen to para hydrogen; and creating a magnetic field around the flowing gas such that (1) conversion of the ortho hydrogen to the para hydrogen is accelerated, (2) heat is removed through a magnetocaloric effect, or (3) both (1) and (2).

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes, and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A device for converting ortho hydrogen to para hydrogen comprising:
a heat exchanger comprising an integrated heat removal system;
a catalytic material coated on the heat exchanger, wherein the catalytic material is configured to convert ortho hydrogen to para hydrogen;
a flow system configured to flow hydrogen through the heat exchanger upon the hydrogen contacting the catalytic material;
a cooling system configured to at least partially remove heat from an ortho hydrogen to para hydrogen conversion;
a monolith within the flow system, wherein the monolith comprises one or more channels for flowing hydrogen therethrough and wherein the monolith is configured such that ortho hydrogen and para hydrogen can flow through the one or more channels one or more times;
a permanent magnet;
an electromagnet; and
a magnetocaloric material between the permanent magnet and the electromagnet, wherein the permanent magnet and the electromagnet are operably connected to the monolith and configured to create a magnetic field that (1) accelerates conversion of the ortho hydrogen to the para hydrogen, (2) removes heat through a magnetocaloric effect, or (3) both (1) and (2).

2. The device of claim 1, wherein the magnetic field is configured to controllably increase or decrease a temperature of the magnetocaloric material.

3. The device of claim 1, wherein the heat exchanger is selected from one of a tube heat exchanger, a tube in tube heat exchanger, a fin heat exchanger, spiral wound, or any combination thereof.

4. The device of claim 1 in which the catalytic material comprises an oxide of a metal selected from one of V, Cr, Mn, Fe, Co, Ni, Nd, Pm, Sm, Gd, Eu, Tb, Dy, Ho, and Er or any combination thereof.

5. The device of claim 1 in which the device is configured such that the magnetic field is activated, deactivated, or both according to the heat removal needs of the heat exchanger.

6. The device of claim 1 in which the device is configured such that the magnetic field varies based on a temperature profile of the heat exchanger such that the temperature at which heat is extracted is substantially maximized.

7. The device of claim 1 in which the device is configured such that the magnetic field varies based on a geometry of the heat exchanger such that the temperature at which heat is extracted is substantially maximized.

8. The device of claim 1 in which the device is configured such that the magnetic field varies separately for the catalytic material and the magnetocaloric heat exchanger.

9. The device of claim 1 wherein the cooling system is configured to remove at least a portion of the heat of the ortho to para hydrogen conversion using a magnetocaloric effect.

10. The device of claim 1 in which the magnetocaloric material comprises an oxide of a metal selected from one of V, Cr, Mn, Fe, Co, Ni, Nd, Pm, Sm, Gd, Eu, Tb, Dy, Ho, and Er or any combination thereof.

11. The device of claim 1 in which the magnetocaloric material comprises one or more metals selected from one of Al, Si, Ca, V, Cr, Mn, Fe, Co, Ni, La, Nd, Pm, Sm, Gd, Eu, Tb, Dy, Ho, Er, or any combination thereof.

12. A device for converting ortho hydrogen to para hydrogen comprising:
a heat exchanger comprising an integrated heat removal system;
a catalytic material coated on the heat exchanger, wherein the catalytic material is configured to convert ortho hydrogen to para hydrogen;
a flow system configured to flow hydrogen through the heat exchanger upon the hydrogen contacting the catalytic material;
a cooling system configured to remove heat from an ortho hydrogen to para hydrogen conversion; and
a monolith, wherein the monolith comprises one or more channels for flowing hydrogen therethrough, wherein the monolith is configured such that ortho hydrogen and para hydrogen can flow through the one or more channels one or more times.

13. The device of claim 12, wherein the one or more channels are coated in the catalytic material.

14. The device of claim 12, wherein the heat exchanger is selected from a tube heat exchanger, a tube in tube heat exchanger, a fin heat exchanger, spiral wound, or any combination thereof.

15. The device of claim 12, wherein the channels comprise a cross-section which is circular, square, or hexagonal.

16. The device of claim 12, wherein the device further comprises a temperature gauge configured to measure the heat exchanger temperature.

17. The device of claim 16, wherein the device further comprises a temperature profile processor configured to generate a temperature profile of the heat exchanger over a predetermined period of time during use.

18. The device of claim 12, wherein the catalytic material comprises iron oxide, chromium oxide, ruthenium oxide or any combination thereof.

19. The device of claim 12, wherein the device is configured to produce liquid hydrogen suitable for fuel consumption.

20. A device for converting ortho hydrogen to para hydrogen comprising:
a heat exchanger comprising an integrated heat removal system;
a catalytic material coated on the heat exchanger, wherein the catalytic material is configured to convert ortho hydrogen to para hydrogen;
a flow system configured to flow hydrogen through the heat exchanger upon the hydrogen contacting the catalytic material; and
a cooling system configured to remove heat from an ortho hydrogen to para hydrogen conversion.

21. The device of claim 20, wherein the device further comprises a monolith further comprising one or more channels configured for the flow of hydrogen, wherein the one or more channels are comprised of extruded ceramic honeycomb-like structures, wherein the interior of each channel is coated in the catalytic material.

22. The device of claim 20, wherein the device further comprises a monolith further comprising one or more channels configured for the flow of hydrogen, wherein the monolith further shaped in a corrugated metal spiral wound.

23. The device of claim 20, wherein the device further comprises:
a monolith further comprising one or more channels configured for the flow of hydrogen;
one or more heat transfer fins configured to facilitate the flow of hydrogen through the one or more channels, wherein each heat transfer fin is coated in the catalytic material.

24. A process for converting ortho hydrogen to para hydrogen comprising:
flowing a gas comprising ortho hydrogen through one or more channels of a monolith in the presence of a catalyst under conditions to convert ortho hydrogen to para hydrogen; and
creating a magnetic field around the flowing gas such that (1) conversion of the ortho hydrogen to the para hydrogen is accelerated, (2) heat is removed through a magnetocaloric effect, or (3) both (1) and (2).
